(19) United States
(12) Patent Application Publication
(10) Pub. No.: US 2025/0242994 A1
(43) Pub. Date: Jul. 31, 2025

(54) INSULATED REPLACEABLE SLEEVE FOR PITCHER

(71) Applicant: Grace Vanden Heuvel, Newton (CA)

(72) Inventor: Grace Vanden Heuvel, Newton (CA)

(21) Appl. No.: 19/041,347

(22) Filed: Jan. 30, 2025

(30) Foreign Application Priority Data
Jan. 31, 2024 (CA) 3227787

(51) Int. Cl. B65D 81/38; G01K 11/12

(52) U.S. Cl. CPC B65D 81/3876; G01K 11/12

(57) ABSTRACT

An insulated replaceable sleeve that is configured to be surroundably mounted to a pitcher such as but not limited to a milk pitcher. The invention includes a wall member that is integrally formed with a bottom creating an interior volume of suitable size to receive a pitcher therein. The wall member includes a first layer and a second layer wherein the second layer is adjacent the pitcher and is manufactured from a thermal insulating material. The wall member has formed at the upper perimeter thereof a perforated member that is employed to facilitate removal of the sleeve from the pitcher. The outer surface of the first layer of the wall member has decorative indicia imprinted thereon. A temperature member is present on the wall member and employs thermochromic materials to provide a visual reading of the temperature of the wall member. A writing member is present on the wall member.

### FIELD OF THE INVENTION

The present invention relates generally to beverage vessel accessories, more specifically but not by way of limitation, a sleeve that is configured to be releasably secured to a beverage vessel, such as but not limited to a milk pitcher, wherein the sleeve includes a decorative outer surface and further provides thermal insulation for the pitcher.

### BACKGROUND

There are numerous types of beverage vessels that are utilized by individuals to store and dispense beverages. One common type of beverage vessel is a pitcher. As is known in the art, a pitcher is typically a larger vessel that can be configured with or without a lid and has a handle secured to the side thereof. Pitcher are employed to store numerous types of beverages. One type of pitcher is commonly referred to as a milk pitcher. The conventional milk pitcher is sized so as to accommodate therein a milk bag. Milk bags are utilized in many areas to package milk for retail sale. Individuals will purchase the milk bag and will typically cut off a corner of the bag and place the bag in a milk pitcher for subsequent dispensing thereof.

Conventional milk pitchers are typically manufactured from plastic and are provided in a few generic colors. As milk pitchers are occasionally set out on a table during gatherings, it would be desirable to be able to enhance the appearance of the milk pitcher. Furthermore, as seasonal gathering of various types are common, an ability to change the outer decorative appearance of the milk pitcher to coordinate with the seasonal gathering or other event is desired by individuals. Additionally, conventional milk pitchers do not provide thermal isolation of the interior volume thereof and as milk is quite perishable, it is desirable to provide an ability to thermally isolate the interior volume of the pitcher.

Accordingly, there is a need for an insulated sleeve that is configured to be releasably secured and surroundably mounted to a milk pitcher wherein the present invention includes a decorative outer surface and further provides functions such as but not limited to temperature monitoring.

### SUMMARY OF THE INVENTION

It is the object of the present invention to provide a sleeve configured to be releasably secured around a milk pitcher wherein the present invention includes a wall member having a bottom integrally formed therewith that is sized to surroundably mount a milk pitcher.

Another object of the present invention is to provide an insulated replaceable sleeve that is operable to be surroundably mounted to a milk pitcher wherein the wall member includes a first layer and a second layer.

A further object of the present invention is to provide a sleeve configured to be releasably secured around a milk pitcher wherein the sleeve includes a perforated member proximate the upper end and opening thereof that is configure to provide a technique for removal of the sleeve from the milk pitcher.

Yet a further object of the present invention is to provide an insulated replaceable sleeve that is operable to be surroundably mounted to a milk pitcher wherein the outer surface of the first layer of the wall member includes decorative indicia.

Still another object of the present invention is to provide a sleeve configured to be releasably secured around a milk pitcher wherein the outer surface of the first later of the wall member has a thermometer integrally formed thereon.

An additional object of the present invention is to provide an insulated replaceable sleeve that is operable to be surroundably mounted to a milk pitcher that further includes a writing surface wherein the writing surface is integrally formed on the outer surface of the first layer of the wall member.

Yet a further object of the present invention is to provide a sleeve configured to be releasably secured around a milk pitcher wherein the sleeve of the present invention employs a pressure sensitive adhesive or other suitable technique and/or adhesive to releasably secure to the exterior of a milk pitcher.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective side view of the present invention and a mateable milk pitcher; and

FIG. 2 is a cross sectional of the present invention; and

FIG. 3 is a perspective view of the present invention releasably secured to an exemplary milk pitcher.

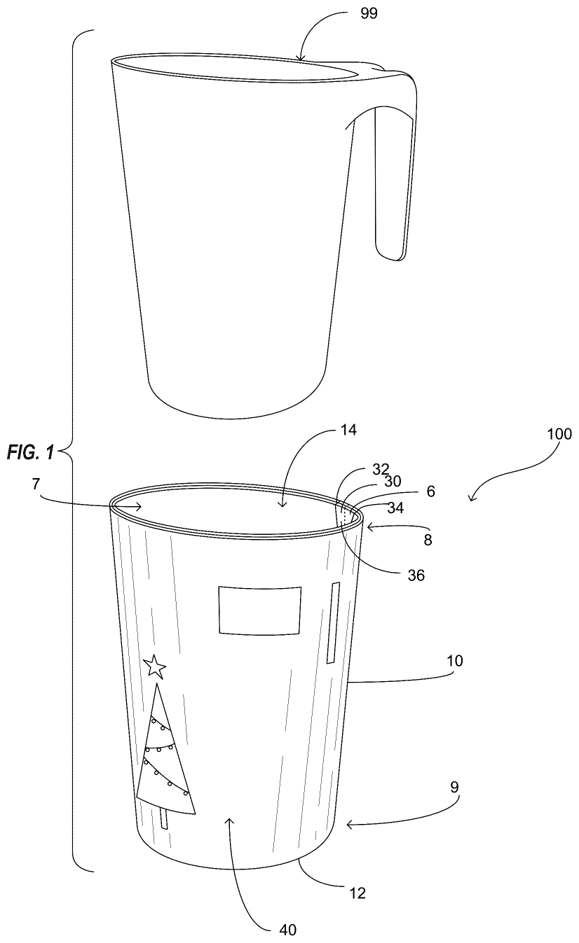

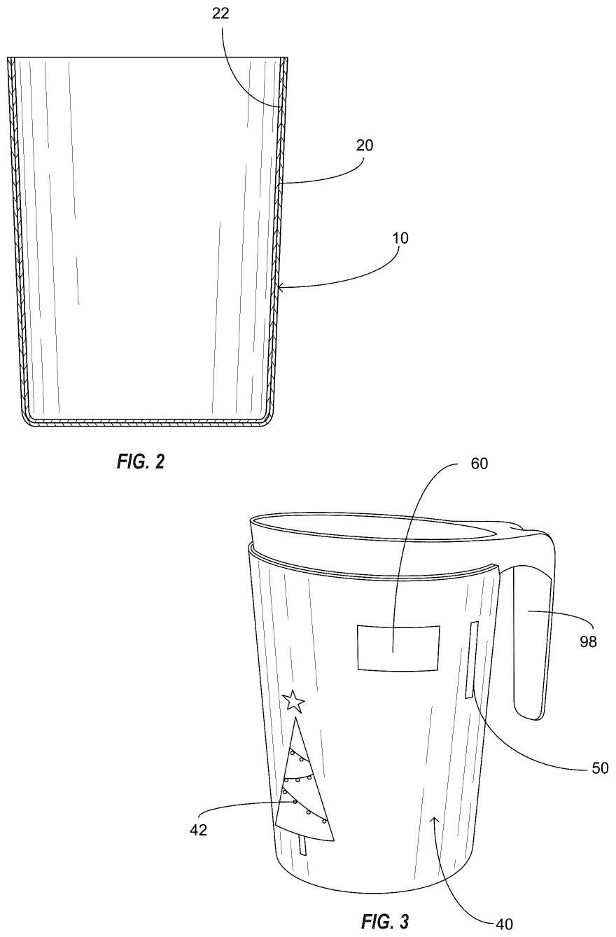

### DETAILED DESCRIPTION

Referring now to the drawings submitted herewith, wherein various elements depicted therein are not necessarily drawn to scale and wherein through the views and figures like elements are referenced with identical reference numerals, there is illustrated an insulated replaceable sleeve 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the insulated replaceable sleeve 100 includes a wall member 10 that is contiguously formed with a bottom member 12 forming an interior volume 14 suitable in size to accommodate an exemplary pitcher 99 therein. While a bottom member 12 is illustrated and discussed herein, it is contemplated within the scope of the present invention that the insulated replaceable sleeve 100 could be manufactured without a bottom member 12 having only the wall member 10 configured to surroundably mount the exemplary pitcher 99. The sleeve 100 includes an upper end 8 and lower end 9 wherein an opening 7 is present at the upper end 8 that facilitates the ability to insert the exemplary pitcher 99 into the interior volume 14. It should be understood within the scope of the present invention that the sleeve 100 could be provided in alternate heights and diameters so as to facilitate an ability to surroundably mount to pitchers of alternate sizes. It is contemplated within the scope of the present invention that the insulated replaceable sleeve 100 is releasably secured to the pitcher 99 employing a pressure sensitive adhesive or other suitable type of adhesive that releasably secures the insulated replaceable sleeve 100 to the pitcher 99 and permits subsequent removal thereof.

The wall member 10 includes a first layer 20 and a second layer 22. The first layer 20 and second layer 22 are adjacent each other and integrally formed to create the wall member 10. The second layer 22 is manufactured from a suitable insulating material so as to provide thermal insulation for the interior volume 14 and as such the pitcher 99 disposed therein. It is contemplated within the scope of the present invention that the second layer 22 could be manufactured from various alternate suitable materials that provide thermal insulation. Furthermore, it is contemplated within the scope of the present invention that the wall member 10 could be manufactured with only the first layer 20 serving as a decorative layer only having no thermal insulation properties. The first layer 20 is manufactured from a suitable material such as but not limited to plastic film. The sleeve 100 includes perforated member 30 integrally formed with the wall member 10. The perforated member 30 extends downward from the upper perimeter edge 6 being generally V-shaped having a first end 32 and a second end 34. The perforated member 30 provides an ability for a user to remove the sleeve 100 from the pitcher 99 as the perforated member 30 is operable to be torn away due to the perforations 36 intermediate the first end 32 and second end 34. The perforated member 30 is positioned on the wall member 10 so as to be aligned with the handle 98 of the pitcher 99 so as to provide concealment thereof ensuing the sleeve 100 being releasably secured to the pitcher 99. While a perforated member 30 is illustrated and discussed herein, it is contemplated within the scope of the present invention that the sleeve 100 could employ alternate elements to facilitate the removal of the sleeve 100.

The outer surface 40 of the first layer 20 of the wall member 10 includes indicia 42 imprinted thereon. It is contemplated within the scope of the present invention that the numerous alternate types, sizes and colors of indicia 42 could be imprinted on the outer surface 40. Integrally formed on the outer surface 40 is a temperature member 50. The temperature member 50 is configured to provide a reading of the temperature of the wall member 10 and as such provide an indication of the temperature of the interior volume of the pitcher 99. The temperature member 50 is manufactured from thermochromic materials and is configured to employ leuco dyes or other suitable material to provide a visual indication of the temperature of the wall member 10. It should be understood within the scope of the present invention that the temperature member 50 could be manufactured from various suitable materials that are operable to provide temperature readings of a surface.

A writing member 60 is integrally formed on the outer surface 40 of the first layer 20 of the wall member 10. The writing member 60 is manufactured from an alternate material utilized for the wall member 10. The writing member 60 is generally rectangular in shape and is manufactured from a material that permits writing media to mark thereon and subsequently be easily removed therefrom. It should be understood within the scope of the present invention that the writing member 60 could be provided in various sizes and shapes. Furthermore, it is contemplated within the scope of the present invention that the writing member 60 could be manufactured from numerous suitable materials.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An insulated replaceable sleeve that is configured to be releasably secured to a pitcher wherein the sleeve comprises:
a wall member, said wall member being integrally formed with a bottom member forming an interior volume, said wall member having a first layer and a second layer, said wall member having an upper end wherein an opening is present at said upper end, said opening providing access to said interior volume, said bottom being proximate a lower end of said wall member, said first layer of said wall member having an outer surface, said outer surface having decorative indicia imprinted thereon, said second layer of said wall member being manufactured from a thermal insulating material; and
a writing member, said writing member being present on said outer surface of said first layer of said wall member, said writing member configured to have writing media marked thereon and subsequently removed.

2. The insulated replaceable sleeve that is configured to be releasably secured to the pitcher as recited in claim 1, and further including a temperature member, said temperature member being present on said first layer of said wall member, said temperature member configured to detect and present a temperature of the wall member.

3. The insulated replaceable sleeve that is configured to be releasably secured to the pitcher as recited in claim 2, wherein said wall member further includes a perforated member, said perforated member being proximate an upper perimeter edge of said wall member, said perforated member having a first end and a second end, wherein said first end and said second end are proximate said upper perimeter edge.

4. The insulated replaceable sleeve that is configured to be releasably secured to the pitcher as recited in claim 3, wherein said temperature member employs thermochromic dyes to provide a visual indication of the temperature of the wall member.

5. The insulated replaceable sleeve that is configured to be releasably secured to the pitcher as recited in claim 4, wherein the perforated member is adjacent a handle of the pitcher ensuing the insulated replaceable sleeve being releasably secured to the pitcher.

6. The insulated replaceable sleeve that is configured to be releasably secured to the pitcher as recited in claim 5, wherein the first layer of the wall member is manufactured from a plastic film.
